(19) United States
(12) Patent Application Publication
(10) Pub. No.: US 2017/0109278 A1
(43) Pub. Date: Apr. 20, 2017

(54) METHOD FOR CACHING AND INFORMATION PROCESSING APPARATUS

(71) Applicant: FUJITSU LIMITED, Kawasaki-Shi (JP)

(72) Inventor: Hirobumi Yamaguchi, Kawasaki (JP)

(73) Assignee: FUJITSU LIMITED, Kawasaki-Shi (JP)

(21) Appl. No.: 15/277,311

(22) Filed: Sep. 27, 2016

(30) Foreign Application Priority Data
Oct. 19, 2015 (JP) 2015-205339

(51) Int. Cl. G06F 12/0811; G06F 12/0842; G06F 12/0862; G06F 12/084

(52) U.S. Cl. CPC G06F 12/0811; G06F 12/084; G06F 12/0842; G06F 12/0862; G06F 2212/1021; G06F 2212/1024; G06F 2212/151; G06F 2212/507; G06F 2212/602; G06F 2212/6024; G06F 2212/6042

(57) ABSTRACT

An information processing apparatus includes a memory, a second processor, and a first processor. The second processor is configured to implement a virtual machine that accesses the memory. The first processor is coupled with the memory. The first processor is configured to read out first data from a first area of the memory. The first area is to be accessed by the virtual machine. The first processor is configured to store the first data in a cache of the first processor.

### CROSS-REFERENCE TO RELATED APPLICATION

This application is based upon and claims the benefit of priority of the prior Japanese Patent Application No. 2015-205339, filed on Oct. 19, 2015, the entire contents of which are incorporated herein by reference.

### FIELD

The embodiments discussed herein are related to a method for caching and an information processing apparatus.

### BACKGROUND

In a system that provides cloud services and the like, virtualization software (a hypervisor, for example), which runs on hardware such as a processor and a memory, is used to create virtual machines (VMs) for individual customers. Although an assignment of the number of cores in the processor and a memory size to each VM is determined in accordance with the contract or the like, the assignment may be flexibly changed in accordance with the customer's request.

A system as described above is generally a multi-processor system. When a memory (local memory) is allocated to each processor, the multi-processor system is problematic in that the performance of the VM is lowered due to accesses to a remote memory. The remote memory is a memory allocated to another processor.

A related technique is disclosed in, for example, Japanese National Publication of International Patent Application No. 2009-537921.

### SUMMARY

According to an aspect of the present invention, provided is an information processing apparatus including a memory, a second processor, and a first processor. The second processor is configured to implement a virtual machine that accesses the memory. The first processor is coupled with the memory. The first processor is configured to read out first data from a first area of the memory. The first area is to be accessed by the virtual machine. The first processor is configured to store the first data in a cache of the first processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a remote memory;

FIG. 2 is a diagram illustrating a configuration of an information processing apparatus according to a first embodiment;

FIG. 3 is a flowchart illustrating processing performed by a remote access management unit according to the first embodiment;

FIG. 4 is a diagram illustrating an example of data that identifies CPU package assignment and memory assignment;

FIG. 5 is a flowchart illustrating processing performed by an access data collection unit;

FIG. 6 is a diagram illustrating conversion performed by using an EPT;

FIG. 7 is a diagram illustrating an example of data stored in an access table;

FIG. 8 is a diagram illustrating an example of data stored in an access management table;

FIG. 9 is a flowchart illustrating processing performed by a cache miss data collection unit;

FIG. 10 is a diagram illustrating an example of data stored in a cache miss table;

FIG. 11 is a diagram illustrating an example of data stored in a cache miss management table;

FIG. 12 is a flowchart illustrating processing performed by a cache fill unit according to the first embodiment;

FIG. 13 is a diagram illustrating latency reduction;

FIG. 14A is a diagram illustrating a configuration of an information processing apparatus according to a second embodiment;

FIG. 14B is a diagram illustrating a configuration of a memory access monitor unit;

FIG. 15 is a flowchart illustrating processing performed by a remote access management unit according to the second embodiment;

FIG. 16 is a diagram illustrating an example of data stored in a filter table;

FIG. 17 is a flowchart illustrating processing performed by the memory access monitor unit;

FIG. 18 is a diagram illustrating an example of data stored in an access history table;

FIG. 19 is a flowchart illustrating processing performed by a cache fill unit according to the second embodiment; and

FIG. 20 is a diagram illustrating a configuration of an information processing apparatus according to a third embodiment.

### DESCRIPTION OF EMBODIMENTS

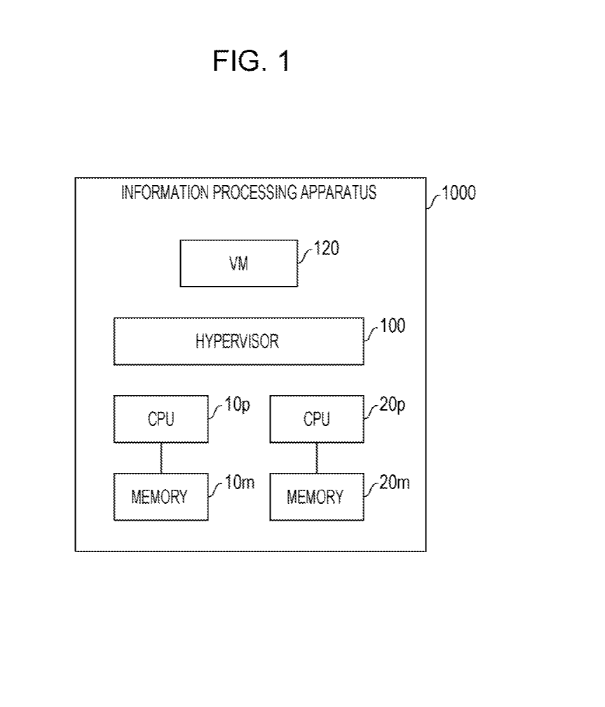

In a system that provides Infrastructure as a Service (IaaS), for example, an assignment of the number of cores in each central processing unit (CPU) and a memory size to each virtual machine (VM) is determined in accordance with the customer's request. Now, an information processing apparatus 1000 as illustrated in FIG. 1 will be considered. The information processing apparatus 1000 includes a CPU 10p, a memory 10m allocated to the CPU 10p, a CPU 20p, and a memory 20m allocated to the CPU 20p. A hypervisor 100 operates on these hardware components. The hypervisor 100 creates a VM 120.

In the example in FIG. 1, three cases may occur for the CPUs; a case in which only a core in the CPU 10p is assigned to the VM 120, a case in which only a core in the CPU 20p is assigned to the VM 120, and a case in which both a core in the CPU 10p and a core in the CPU 20p are assigned to the VM 120. For the memories as well, three cases may occur; a case in which only the memory 10m is assigned to the VM 120, a case in which only the memory 20m is assigned to the VM 120, and a case in which both the memory 10m and the memory 20m are assigned to the VM 120.

Then, there is a case in which a memory allocated to a CPU that is not assigned to the VM 120 (that is, a remote memory) is assigned to the VM 120. For example, if the CPU 10p is assigned to the VM 120 and both the memories 10m and 20m are assigned to the VM 120, the memory 20m is a remote memory.

A remote memory may occur not only in a system that provides IaaS but also in another system. In a system in which a license fee is determined based on the number of cores, for example, there may be a case in which the number of cores assigned to a VM is limited and a memory size is increased. A remote memory occurs in this case.

A method of increasing the speed of accessing data stored in a remote memory will be descried below.

### First Embodiment

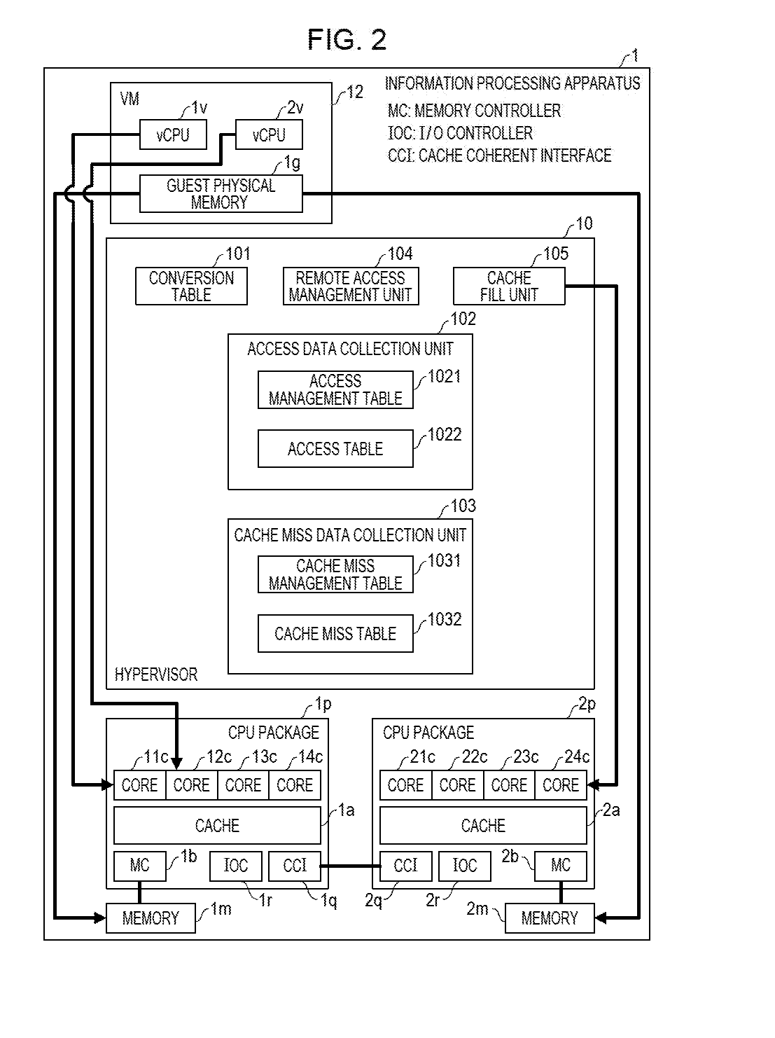

FIG. 2 illustrates a configuration of an information processing apparatus 1 according to a first embodiment. The information processing apparatus 1 includes a CPU package 1p, a memory 1m which is, for example, a dual inline memory module (DIMM), a CPU package 2p, and a memory 2m which is, for example, a DIMM. The memory 1m is allocated to the CPU package 1p, and the memory 2m is allocated to the CPU package 2p. The information processing apparatus 1 complies with the Peripheral Component Interconnect (PCI) Express standard.

The CPU package 1p includes cores 11c to 14c, a cache 1a, a memory controller 1b (abbreviated as MC in FIG. 2), an input/output (I/O) controller 1r (abbreviated as IOC in FIG. 2), and a cache coherent interface 1q (abbreviated as CCI in FIG. 2). Similarly, the CPU package 2p includes cores 21c to 24c, a cache 2a, a memory controller 2b, an I/O controller 2r, and a cache coherent interface 2q.

The cores 11c to 14c and the cores 21c to 24c execute commands in programs.

The caches 1a and 2a are each a storage area in which information (for example, addresses and data themselves) about memory accesses performed by cores is stored. According to the first embodiment, each CPU package includes a level-1 (L1) cache, a level-2 (L2) cache, and a level-3 (L3) cache. The L3 cache is shared among the cores.

The memory controllers 1b and 2b each control accesses to the relevant memory. The memory controller 1b is coupled with the memory 1m, and the memory controller 2b is coupled with the memory 2m.

The I/O controllers 1r and 2r, each of which is a controller used for a connection to an I/O interface such as the PCI Express, perform processing to convert a protocol used in the relevant CPU package into an I/O interface protocol and perform other processing.

The cache coherent interfaces 1q and 2q are each, for example, the Intel Quick Path Interconnect (QPI) or the Hyper Transport. The cache coherent interfaces 1q and 2q perform communications with another CPU package such as, for example, communications to maintain cache coherency.

Programs for a hypervisor 10 are stored in at least either one of the memories 1m and 2m, and are executed by at least either one of a core in the CPU package 1p and a core in the CPU package 2p. The hypervisor 10 manages assignment of hardware to a VM 12. The hypervisor 10 includes a conversion table 101, which is used to convert a guest physical address into a host physical address, an access data collection unit 102, a cache miss data collection unit 103, a remote access management unit 104, and a cache fill unit 105. The access data collection unit 102 manages an access management table 1021 and an access table 1022. The cache miss data collection unit 103 manages a cache miss management table 1031 and a cache miss table 1032. The conversion table 101, access management table 1021, access table 1022, cache miss management table 1031, and cache miss table 1032 will be described later.

The VM 12 includes a virtualized CPU (vCPU) 1v and a vCPU 2v, which are virtualized CPUs, and also includes a guest physical memory 1g which is a virtualized physical memory. A guest operating system (OS) operates on virtualized hardware.

In the first embodiment, it is assumed that the vCPU 1v is implemented by the core 11c, the vCPU 2v is implemented by the core 12c, and the guest physical memory 1g is implemented by the memories 1m and 2m. That is, it is assumed that a remote memory (memory 2m) is assigned to the VM 12. The cache fill unit 105 is implemented when a program corresponding thereto is executed by the core 24c. However, the program for the cache fill unit 105 may be executed by a plurality of cores. A program for the access data collection unit 102, a program for the cache miss data collection unit 103, and a program for the remote access management unit 104 may be executed by any core.

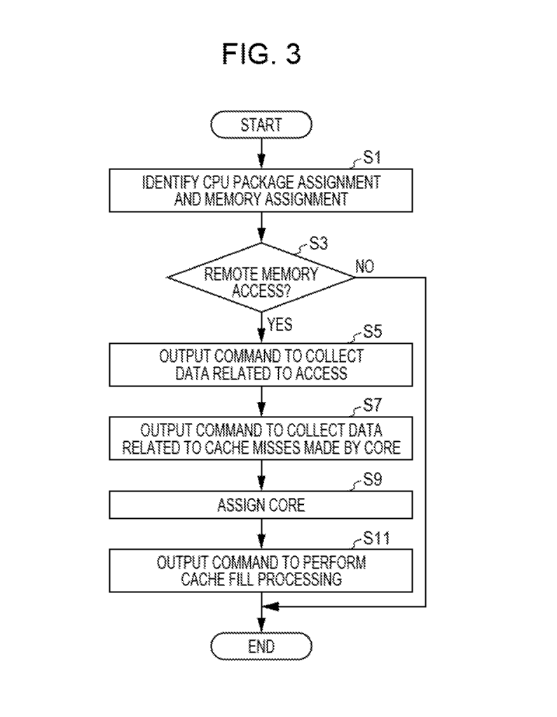

Next, operations of the information processing apparatus 1 according to the first embodiment will be described with reference to FIGS. 3 to 12.

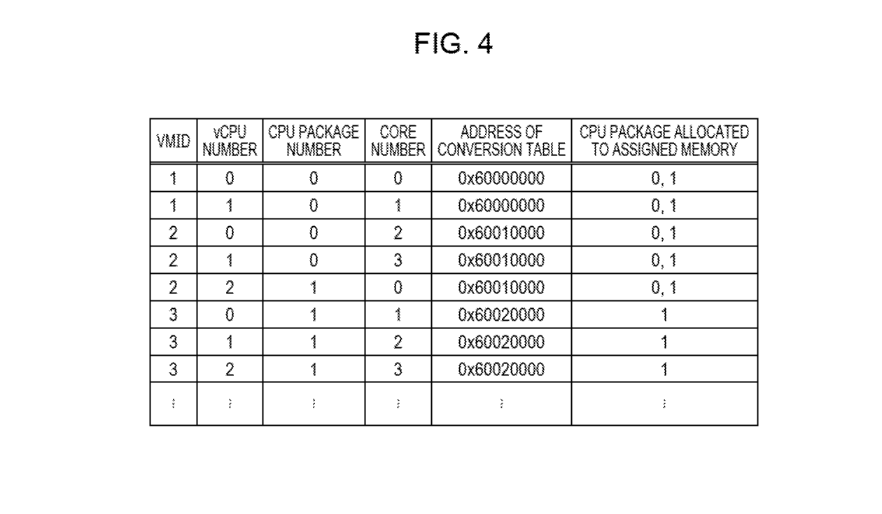

First, processing performed by the remote access management unit 104 at the time of creating the VM 12 will be described with reference to FIGS. 3 and 4. When the VM 12 is created by the hypervisor 10, the remote access management unit 104 identifies a CPU package assignment and memory assignment to the created VM 12 (referred to below as a target VM) (S1 in FIG. 3).

Usually, the hypervisor 10 manages data as illustrated in FIG. 4. In S1, the CPU package assignment and memory assignment are identified based on data as illustrated in FIG. 4. In the example in FIG. 4, data managed is a VMID, which is an identifier of a VM, a vCPU number of the VM, the number of a CPU package which includes a core assigned to the VM, the number of a core assigned to the VM, an address of the conversion table 101 for the VM, and the numbers of CPU packages, each of which is allocated with a memory assigned to the VM. In the example in FIG. 4, the VM with a VMID of 1 uses the memory allocated to the CPU package numbered 1 as a remote memory at all times.

Referring again to FIG. 3, the remote access management unit 104 determines whether the target VM performs a remote memory access (S3). The remote memory access is an access to a remote memory performed by a VM.

If the target VM does not perform a remote memory access (No in S3), the processing is terminated. If the target VM performs a remote memory access (Yes in S3), the remote access management unit 104 outputs, to the access data collection unit 102, a command to collect data related to accesses performed by the target VM (S5). This collection command includes the VMID of the target VM, a designation of an execution interval and a designation of a generation number. Processing performed by the access data collection unit 102 will be described later.

The remote access management unit 104 outputs, to the cache miss data collection unit 103, a command to collect data related to cache misses made by the core used by the target VM (S7). This collection command includes the number of the core assigned to the target VM and the VMID of the target VM, which are indicated in FIG. 4, a designation of a wait time, and a designation of a generation number. Processing performed by the cache miss data collection unit 103 will be described later.

The remote access management unit 104 assigns the cache fill unit 105 with a core (here, the core 24c is assumed) in the CPU package allocated with the remote memory (in the first embodiment, the memory 2m) (S9). In S9, the core 24c is instructed to execute the program for the cache fill unit 105. Then, the core 24c enters a state in which the core 24c waits for an execution command.

The remote access management unit 104 outputs, to the cache fill unit 105, an execution command to perform cache fill processing by using three algorithms Algorithm_A, Algorithm_B, and Algorithm_C (S11). Thereafter, the processing is terminated. The execution command includes a designation of a wait time.

Through the processing described above, the access data collection unit 102, cache miss data collection unit 103, and cache fill unit 105 become ready to start processing thereof for the VM that accesses the remote memory.

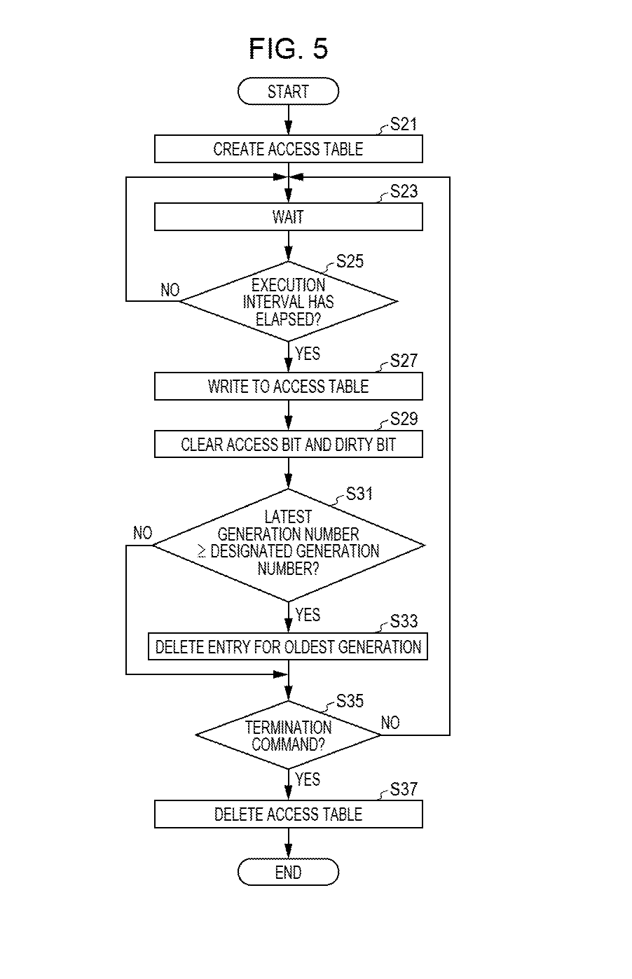

Next, processing performed by the access data collection unit 102 will be described with reference to FIGS. 5 to 8. First, upon the receipt of a collection command from the remote access management unit 104, the access data collection unit 102 creates an access table 1022 about the target VM (S21 in FIG. 5). In S21, the access table 1022 is empty. An access management table 1021 is also created in S21 as a table used for the management of the access table 1022.

The access data collection unit 102 waits until the target VM stops (S23). In this embodiment, it is assumed that the target VM repeatedly operates and stops at short intervals.

The access data collection unit 102 determines whether the execution interval designated in the collection command from the remote access management unit 104 has elapsed (S25).

If the execution interval designated in the collection command from the remote access management unit 104 has not elapsed (No in S25), the processing returns to S23. If the execution interval designated in the collection command from the remote access management unit 104 has elapsed (Yes in S25), the access data collection unit 102 writes data related to the accesses to the remote memory in the access table 1022 on the basis of the conversion table 101 about the target VM (S27). In a case in which it is desirable to update the access management table 1021, the access data collection unit 102 updates the access management table 1021.

As described above, the conversion table 101 is a table used for converting a guest physical address into a host physical address; the conversion table 101 is, for example, the Extended Page Table (EPT) mounted in a processor from Intel Corporation. In the conversion table 101, host physical addresses corresponding to guest physical addresses are managed for each page. When the guest OS accesses a guest physical address, the core automatically references the conversion table 101, calculates a host physical address corresponding to the guest physical address, and accesses the calculated host physical address. Since an access bit and a dirty bit are provided in the conversion table 101, the hypervisor 10 may grasp that the guest OS has read out data from a page and that data has been written to a page.

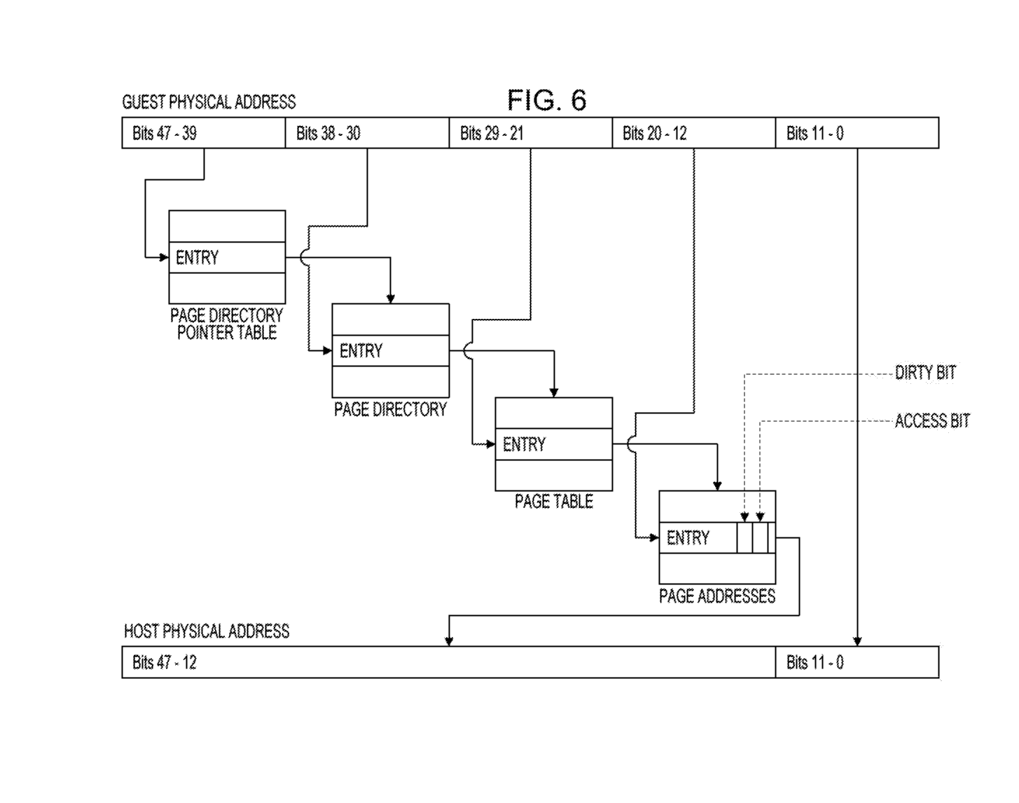

Conversion using the EPT will be briefly described with reference to FIG. 6. In FIG. 6, a 48-bit guest physical address is converted into a 48-bit host physical address. An entry in a page directory pointer table of the EPT is identified by information in bits 39 to 47 of the guest physical address. A page directory of the EPT is identified by the identified entry, and an entry in the page directory is identified by information in bits 30 to 38 of the guest physical address. A page table of the EPT is identified by the identified entry, and an entry in the page table is identified by information in bits 21 to 29 of the guest physical address. The last table is identified by the identified entry, and an entry in the last table is identified by information in bits 12 to 20 of the guest physical address. Information included in the last identified entry is used as information in bits 12 to 47 of the host physical address. An access bit and a dirty bit have been added to this information. The access bit indicates a read access, and the dirty bit indicates a write access. Information in bits 0 to 11 of the guest physical address is used as information in bits 0 to 11 of the host physical address.

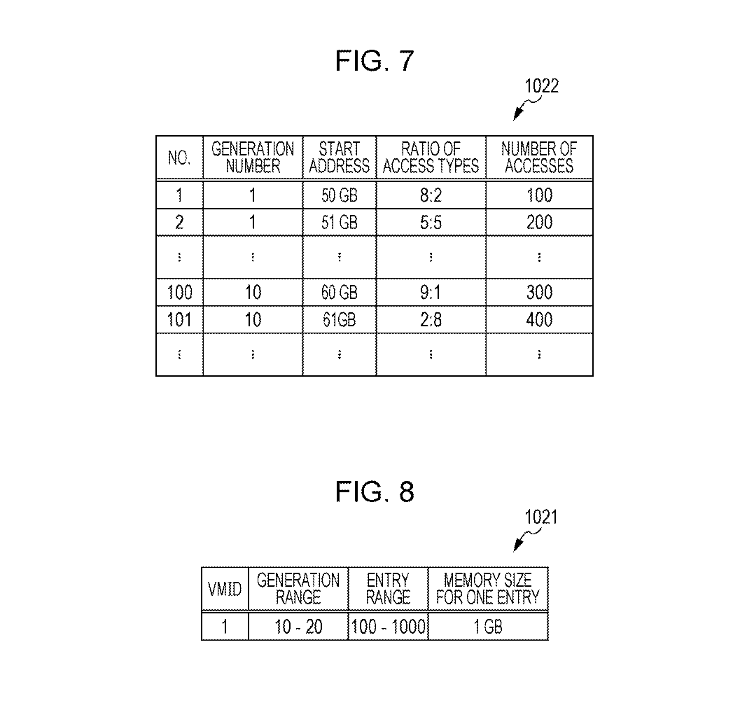

In S27, data related to accesses made by the target VM is collected from the conversion table 101. FIG. 7 illustrates an example of data stored in the access table 1022. In the example in FIG. 7, the access table 1022 stores therein the number of each entry, a number representing a generation in which the entry has been created, the start address of a memory area corresponding to the entry (in FIG. 7, information about the page including the start address), a ratio of access types, and the number of accesses. The access table 1022 is provided for each VM. Only entries for memory areas of remote memories are created in the access table 1022. Therefore, the amount of resources used may be reduced.

FIG. 8 illustrates an example of data stored in the access management table 1021. In the example in FIG. 8, the access management table 1021 stores therein a VMID, the range of the generation numbers of entries stored in the access table 1022, the range of the entry numbers of these entries stored in the access table 1022, and the size of a memory area for one entry. According to the first embodiment, the memory area is managed by using a size equal to or larger than the size of the page in the EPT. Accordingly, the amount of processing overhead and the amount of resources used may be reduced when compared with a case in which the EPT is used as data used for management.

Referring again to FIG. 5, the access data collection unit 102 clears the access bit and dirty bit in the conversion table 101 corresponding to the target VM (S29).

The access data collection unit 102 determines whether the latest generation number stored in the access table 1022 is equal to or larger than the generation number designated in the collection command from the remote access management unit 104 (S31).

If the latest generation number stored in the access table 1022 is less than the generation number designated in the collection command from the remote access management unit 104 (No in S31), the processing proceeds to S35. If the latest generation number stored in the access table 1022 is equal to or larger than the generation number designated in the collection command from the remote access management unit 104 (Yes in S31), the access data collection unit 102 deletes the entry for the oldest generation in the access table 1022 (S33).

The access data collection unit 102 determines whether a collection termination command has been received from the remote access management unit 104 (S35). If a collection termination command has not been received from the remote access management unit 104 (No in S35), the processing returns to S23. If a collection termination command has been received from the remote access management unit 104 (Yes in S35), the access data collection unit 102 deletes the access table 1022 about the target VM (S37). Along with this, the access management table 1021 about the target VM is also deleted. Thereafter, the processing is terminated.

When the processing described above is performed, data about accesses to the remote memory by the target VM may be collected. The created access table 1022 is used in processing performed by the cache fill unit 105.

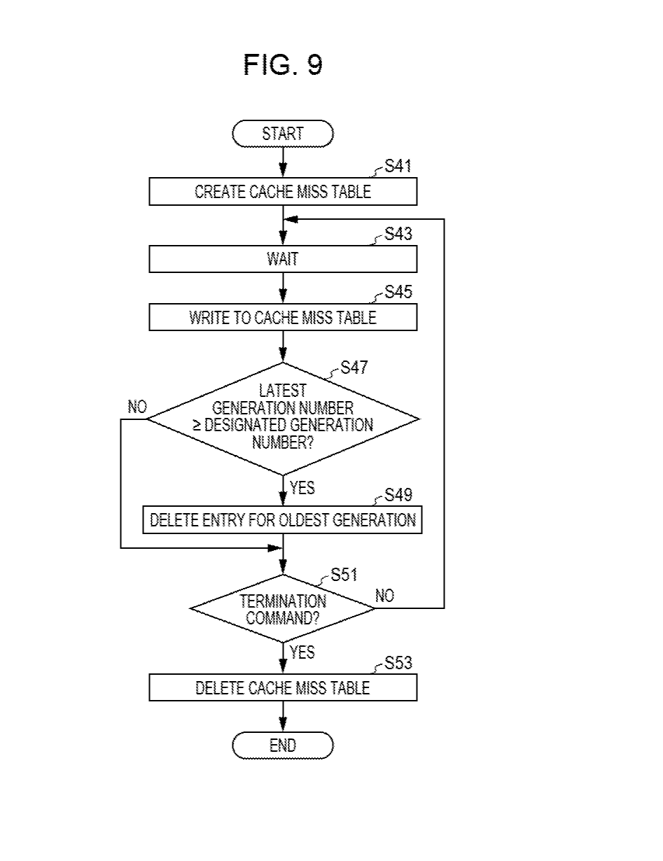

Next, processing performed by the cache miss data collection unit 103 will be described with reference to FIGS. 9 to 11. First, upon the receipt of a collection command from the remote access management unit 104, the cache miss data collection unit 103 creates a cache miss table 1032 about the target VM (S41 in FIG. 9). In S41, the cache miss table 1032 is empty. The cache miss management table 1031 is also created in S41 as a table used for the management of the cache miss table 1032.

The cache miss data collection unit 103 waits for a time (100 milliseconds, for example) designated in the collection command from the remote access management unit 104 (S43).

The cache miss data collection unit 103 acquires the number of cache misses and the number of cache hits from the CPU package assigned to the target VM, and writes the acquired number of cache misses and the acquired number of cache hits to the cache miss table 1032 (S45). It is assumed that the CPU package includes a counter register that counts the number of cache misses and another counter register that counts the number of cache hits. In a case in which it is desirable to update the cache miss management table 1031, the cache miss data collection unit 103 updates the cache miss management table 1031.

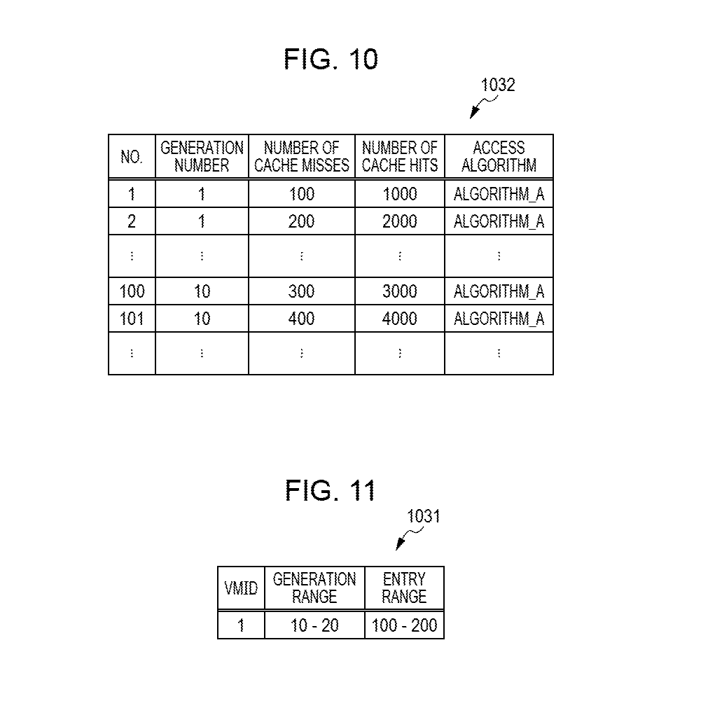

FIG. 10 illustrates an example of data stored in the cache miss table 1032. In the example in FIG. 10, the cache miss table 1032 stores therein the number of each entry, a number representing a generation in which the entry has been created, the number of cache misses, which is the total number of snoop misses made by the vCPU of the VM in the generation, the number of cache hits, which is the total number of times the vCPU of the VM referenced the L3 cache in the generation, and information indicating an algorithm to be adopted by the cache fill unit 105.

FIG. 11 illustrates an example of data stored in the cache miss management table 1031. In the example in FIG. 11, the cache miss management table 1031 stores therein a VMID, the range of the generation numbers of entries stored in the access table 1022, and the range of entry numbers stored in the cache miss table 1032.

Referring again to FIG. 9, the cache miss data collection unit 103 determines whether the latest generation number stored in the cache miss table 1032 is equal to or larger than the generation number designated in the collection command from the remote access management unit 104 (S47).

If the latest generation number stored in the cache miss table 1032 is less than the generation number designated in the collection command from the remote access management unit 104 (No in S47), the processing proceeds to S51. If the latest generation number stored in the cache miss table 1032 is equal to or larger than the generation number designated in the collection command from the remote access management unit 104 (Yes in S47), the cache miss data collection unit 103 deletes the entry for the oldest generation in the cache miss table 1032 (S49).

The cache miss data collection unit 103 determines whether a collection termination command has been received from the remote access management unit 104 (S51). If a collection termination command has not been received from the remote access management unit 104 (No in S51), the processing returns to S43. If a collection termination command has been received from the remote access management unit 104 (Yes in S51), the cache miss data collection unit 103 deletes the cache miss table 1032 about the target VM (S53). Along with this, the cache miss management table 1031 about the target VM is also deleted. Thereafter, the processing is terminated.

When the processing described above is performed, the cache fill unit 105 may use information such as the number of cache misses made by the CPU package assigned to the target VM.

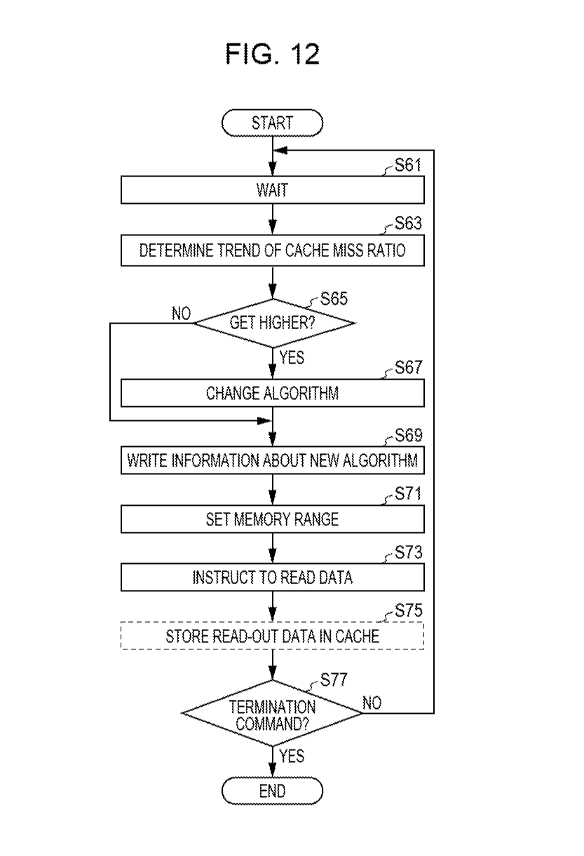

Next, processing performed by the cache fill unit 105 will be described with reference to FIG. 12. First, the cache fill unit 105 waits for a time (100 milliseconds, for example) designated by the remote access management unit 104 (S61 in FIG. 12).

The cache fill unit 105 determines a trend of a cache miss ratio by comparing an average of cache miss ratios in the last two generations with an average of cache miss ratios in the two generations immediately before the last two generations, based on data stored in the cache miss table 1032 created by the cache miss data collection unit 103 (S63). The cache miss ratio is calculated by dividing the number of cache misses by a sum of the number of cache misses and the number of cache hits.

If the average of cache miss ratios in the last two generations does not get higher than the average of cache miss ratios in the two generations immediately before the last two generations (No in S65), the processing proceeds to S69. If the average of cache miss ratios in the last two generations gets higher than the average of cache miss ratios in the two generations immediately before the last two generations (Yes in S65), the cache fill unit 105 changes the algorithm to be adopted by the cache fill unit 105 (S67). For example, if the current algorithm is Algorithm_A, the cache fill unit 105 changes the algorithm to be adopted by the cache fill unit 105 to Algorithm_B. If the current algorithm is Algorithm_B, the cache fill unit 105 changes the algorithm to be adopted by the cache fill unit 105 to Algorithm_C. If the current algorithm is Algorithm_C, the cache fill unit 105 changes the algorithm to be adopted by the cache fill unit 105 to Algorithm_A. Information about the current algorithm is stored in the cache miss table 1032. By the processing in S67, accesses may be made in accordance with an access method in which less cache misses occurs.

The cache fill unit 105 writes information about the new algorithm into the cache miss table 1032 (S69).

Based on the data stored in the access table 1022, the cache fill unit 105 sets a range (memory range) in a memory area, which is to be accessed in accordance with an access method in the adopted algorithm (S71). By the processing in S71, data may be read out from a memory range that has the possibility of being accessed.

In Algorithm_A, the memory range is set to a range that is indicated by the entry having the highest read access ratio among the entries in the latest generation. If a plurality of entries having the highest read access ratio are present, the entry including the highest number of accesses is selected. In Algorithm_B, three entries in the latest generation are sequentially selected starting from the entry having the highest read access ratio, and the memory range is set to ranges indicated by the three entries. In Algorithm_C, it is determined whether the start address of an entry in the latest generation and the start address of an entry in the generation before the latest generation are consecutive. If these start addresses are consecutive, the memory range is set to ranges indicated by the two entries and a range consecutive to the ranges. For example, If the start address of an entry in an (n−1)-th generation is the 50-gigabyte (GB) point and the start address of an entry in an n-th generation is the 51-GB point, the memory range is set to the ranges indicated by the two entries and a range in which its start address is the 52-GB point. If, for example, the start address of an entry in an (n−1)-th generation is the 50-gigabyte (GB) point and the start address of an entry in an n-th generation is the 49-GB point, the memory range is set to the ranges indicated by the two entries and a range in which its start address is the 48-GB point.

The cache fill unit 105 instructs the memory controller (memory controller 2b) to read out data from the set memory range in accordance with an access method in the adopted algorithm (S73). In Algorithm_A, for example, data is read out randomly from the set memory range by an amount equal to the L3 cache size in units of a cache line size (64 bytes, for example). In algorithm_B and algorithm_C, a similar access method may be adopted. However, different access methods may be adopted in different algorithms.

The memory controller 2b stores the data read out in S73 into a cache (in the first embodiment, the cache 2a) of the CPU package allocated with the remote memory (S75). Since this processing is not performed by the cache fill unit 105, S75 is indicated by dashed lines.

The cache fill unit 105 determines whether a processing termination command has been received from the remote access management unit 104 (S77). If a processing termination command has not been received (No in S77), the processing returns to S61. If a processing termination command has been received (Yes in S77), the processing is terminated.

When the guest OS in the VM 12 in the information processing apparatus 1 reads out data (target data) at address X in the memory 2m, one of the following four cases may occur in view of caches:

(1) The target data is present in neither the cache 1a nor the cache 2a.

(2) The target data is present only in the cache 1a.

(3) The target data is present only in the cache 2a.

(4) The target data is present in both the cache 1a and the cache 2a.

To be more specific, cases may be classified depending on whether data in the cache matches data in the memory 2m. However, this is irrelevant to this embodiment, so a description thereof will be omitted here.

With a CPU that adopts the Modified, Exclusive, Shared, Invalid, Forwarding (MESIF) protocol as the cache coherent protocol, the latency in cases (2) and (4) is shortest, followed by cases (3) and (1) in that order. In case (1), there are overhead involved in passing through a cache coherent interconnect and overhead involved in the reading of the target data from the memory by the memory controller, the latency is prolonged. In case (3), although there is overhead involved in passing through a cache coherent interconnect, the overhead is shorter than the overhead involved in the reading of the target data from the memory by the memory controller, so the latency in case (3) is shorter than the latency in case (1). In cases (2) and (4), since the target data may be read out from the cache 1a, the above-described two types of overhead does not occur, so the latency is shortest.

If the VM 12 operates for a long time, the core in the CPU package 2p is not assigned to the VM 12, so target data in the memory 2m is not newly held in the cache 2a. Therefore, above-described case (3) rarely occurs. Case (3) may occur only when the target data is accidentally held in the cache 2a before the VM 12 operates.

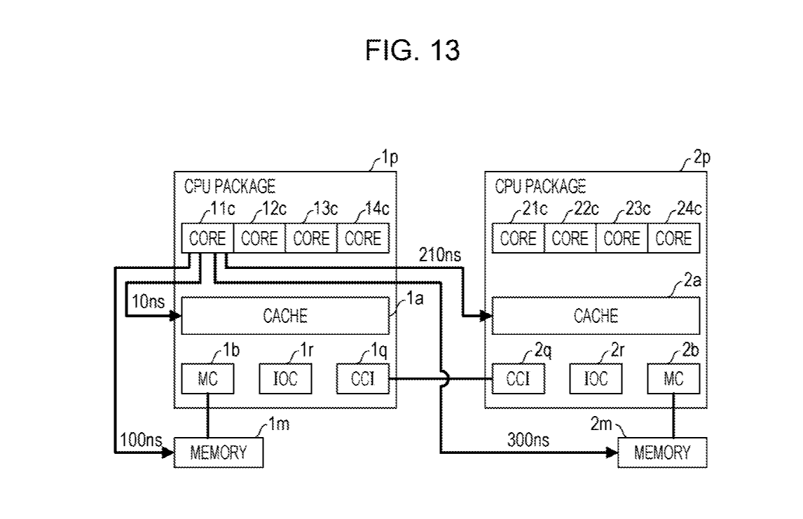

Therefore, when the guest OS in the VM 12 accesses the target data in the memory 2m, which is the remote memory, if the target data is not present in the cache 1a, the latency is prolonged. In the example in FIG. 13, for example, when the target data is present in the cache 1a, the latency is 10 nanoseconds (ns). When the target data is read out from the memory 2m, however, the latency is 300 ns, which is longer than the former case.

According to the present embodiment, the target data stored in the memory 2m may be read out into the cache 2a in advance. When the guest OS in the VM 12 accesses the cache 2a, therefore, the latency may be shortened to 210 ns. In addition, when the target data read out into the cache 2a is copied to the cache 1a through cache coherency, the latency may be further shortened.

That is, according to the present embodiment, the latency in an access to data in the remote memory may be shortened. Furthermore, this may be implemented at a low cost because processing is performed by a hypervisor without modifying the existing hardware or OS.

### Second Embodiment

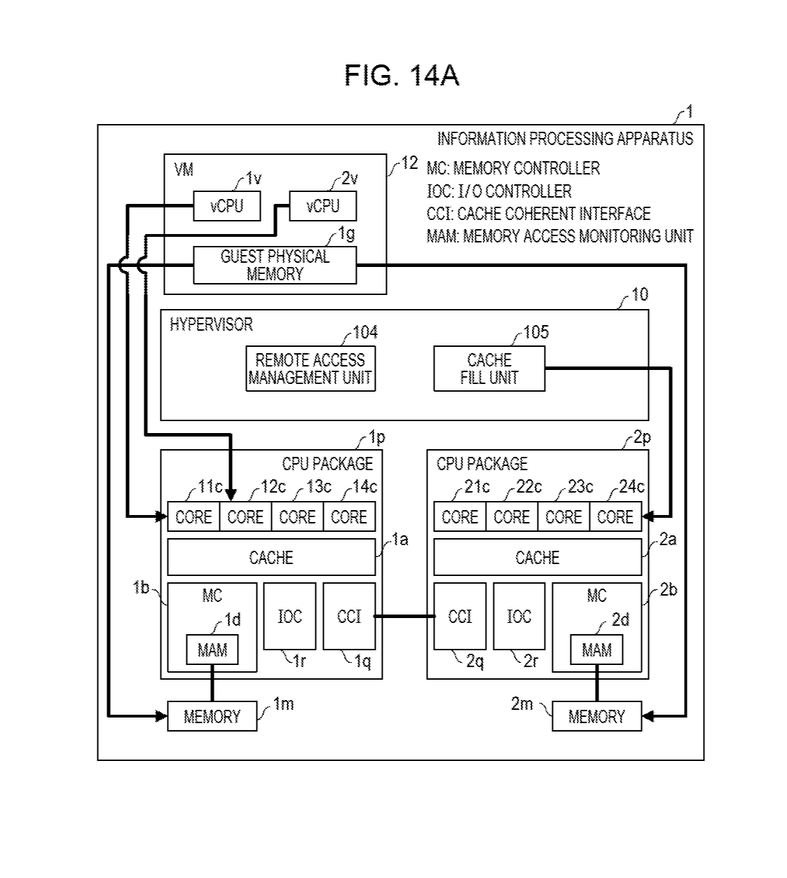

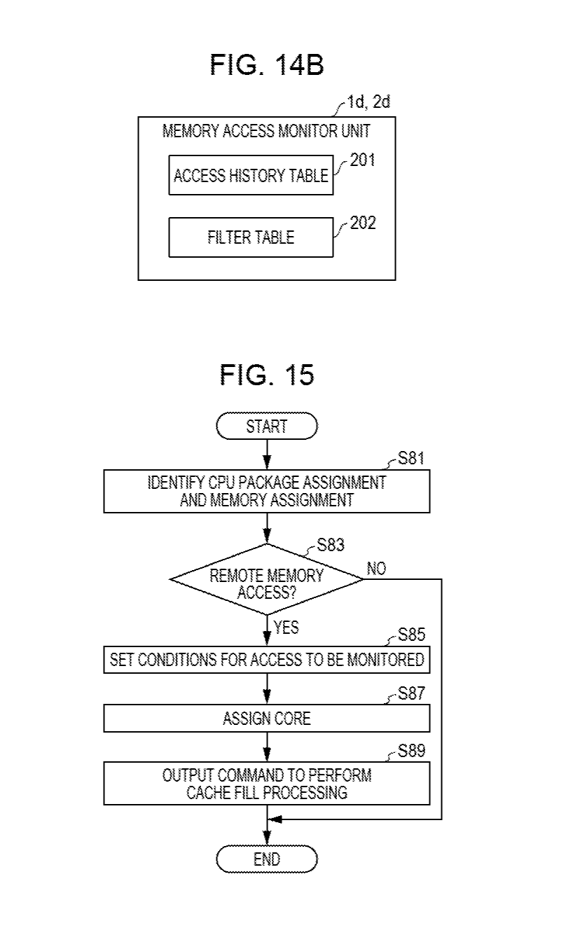

FIG. 14A illustrates a configuration of an information processing apparatus 1 according to a second embodiment. The information processing apparatus 1 includes a CPU package 1p, a memory 1m which is, for example, a DIMM, a CPU package 2p, and a memory 2m which is, for example, a DIMM. The memory 1m is allocated to the CPU package 1p, and the memory 2m is allocated to the CPU package 2p. The information processing apparatus 1 complies with the PCI Express standard.

The CPU package 1p includes cores 11c to 14c, a cache 1a, a memory controller 1b (abbreviated as MC in FIG. 14A), an I/O controller 1r (abbreviated as IOC in FIG. 14A), and a cache coherent interface 1q (abbreviated as CCI in FIG. 14A). Similarly, the CPU package 2p includes cores 21c to 24c, a cache 2a, a memory controller 2b, an I/O controller 2r, and a cache coherent interface 2q.

The cores 11c to 14c and the cores 21c to 24c execute commands in programs. Each core according to the second embodiment has a cache snoop mechanism in a directory snoop method and adopts the MESIF protocol as the cache coherent protocol. Each core may execute a special prefetch command (speculative non-shared prefetch (SNSP) command) used by a cache fill unit 105.

The caches 1a and 2a are each a storage area in which information (for example, addresses and data themselves) about memory accesses performed by cores is stored. According to the second embodiment, each CPU package includes an L1 cache, an L2 cache, and an L3 cache. The L3 cache is shared among the cores.

The memory controllers 1b and 2b each control accesses to the relevant memory. The memory controller 1b includes a memory access monitor unit 1d (abbreviated as MAM in FIG. 14A) and is coupled with the memory 1m. The memory controller 2b includes a memory access monitor unit 2d and is coupled with the memory 2m. FIG. 14B illustrates a configuration of the memory access monitor units 1d and 2d. In the example in FIG. 14B, the memory access monitor units 1d and 2d each manage an access history table 201 and a filter table 202. The access history table 201 and filter table 202 will be described later.

The I/O controllers 1r and 2r, each of which is a controller used for a connection to an I/O interface such as the PCI Express, perform processing to convert a protocol used in the relevant CPU package into an I/O interface protocol and perform other processing.

The cache coherent interfaces 1q and 2q are each, for example, the Intel QPI or the Hyper Transport. The cache coherent interfaces 1q and 2q perform communications with another CPU package such as, for example, communications to maintain cache coherency.

Programs for a hypervisor 10 are stored in at least either one of the memories 1m and 2m, and are executed by at least either one of a core in the CPU package 1p and a core in the CPU package 2p. The hypervisor 10 manages assignment of hardware to the VM 12. The hypervisor 10 includes a remote access management unit 104 and a cache fill unit 105.

The VM 12 includes a vCPU 1v and a vCPU 2v, which are virtualized CPUs, and also includes a guest physical memory 1g which is a virtualized physical memory. A guest OS operates on virtualized hardware.

In the second embodiment, it is assumed that the vCPU iv is implemented by the core 11c, the vCPU 2v is implemented by the core 12c, and the guest physical memory 1g is implemented by the memories 1m and 2m. That is, it is assumed that a remote memory (memory 2m) is assigned to the VM 12.

The cache fill unit 105 is implemented when a program corresponding thereto is executed by the core 24c. However, the program for the cache fill unit 105 may be executed by a plurality of cores. A program for the remote access management unit 104 may be executed by any core.

Next, operations of the information processing apparatus 1 according to the second embodiment will be described with reference to FIGS. 15 to 19.

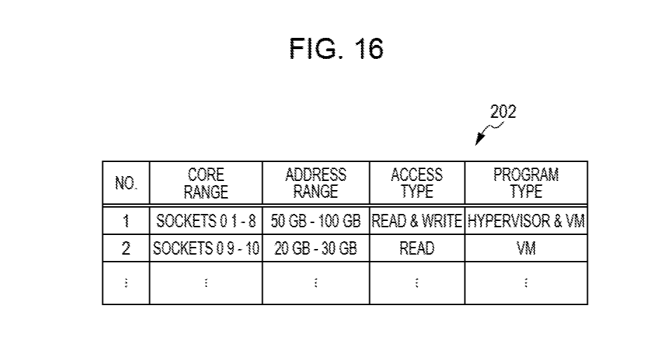

First, processing performed by the remote access management unit 104 at the time of creating the VM 12 will be described with reference to FIGS. 15 and 16. When the VM 12 is created by the hypervisor 10, the remote access management unit 104 identifies a CPU package assignment and memory assignment to the created VM 12 (referred to below as the target VM) (S81 in FIG. 15).

Usually, the hypervisor 10 manages data as illustrated in FIG. 4. In S81, the CPU package assignment and memory assignment are identified based on data as illustrated in FIG. 4.

Referring again to FIG. 15, the remote access management unit 104 determines whether the target VM performs a remote memory access (S83). The remote memory access is an access to a remote memory performed by a VM.

If the target VM does not perform a remote memory access (No in S83), the processing is terminated. If the target VM performs a remote memory access (Yes in S83), the remote access management unit 104 sets, in the filter table 202 of the memory access monitor unit (memory access monitor unit 2d), conditions on accesses to be monitored (S85). The remote access management unit 104 then outputs, to the memory access monitor unit 2d, a command to start memory access monitoring.

FIG. 16 illustrates an example of data stored in the filter table 202. In the example in FIG. 16, the filter table 202 stores therein, the number of each entry, a range of cores to which an access request is issued, a range of memory addresses (in FIG. 16, information about a range of pages including these memory addresses) to be accessed, an access type, and a type of the program that has generated the access. Information about an access that satisfies these conditions is stored in the access history table 201. The access history table 201 and filter table 202 are accessed by the remote access management unit 104 and cache fill unit 105 through, for example, a memory mapped input/output (MMIO) space of the PCI Express standard.

The remote access management unit 104 assigns, to the cache fill unit 105, a core (here, the core 24c is assumed) in the CPU package allocated with the remote memory (in the second embodiment, the memory 2m) (S87). In S87, the core 24c is instructed to execute the program for the cache fill unit 105. Then, the core 24c enters a state in which the core 24c waits for an execution command.

The remote access management unit 104 outputs, to the cache fill unit 105, an execution command to perform cache fill processing at intervals of a prescribed time (100 milliseconds, for example) (S89). The execution command includes information about the page size of the page table of the vCPU used by the target VM. Then, the processing is terminated.

Through the processing described above, the memory access monitor unit 2d and cache fill unit 105 become ready to start processing thereof for the VM that accesses the remote memory.

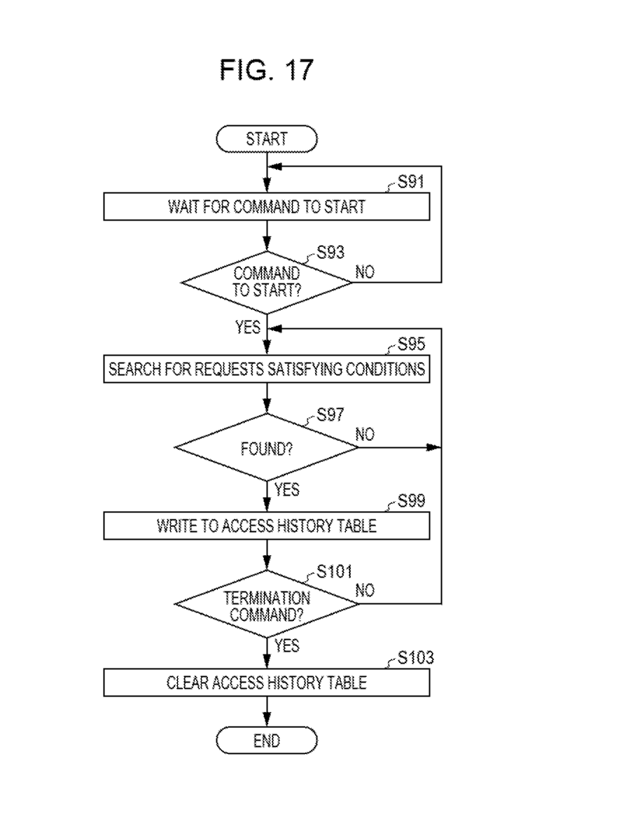

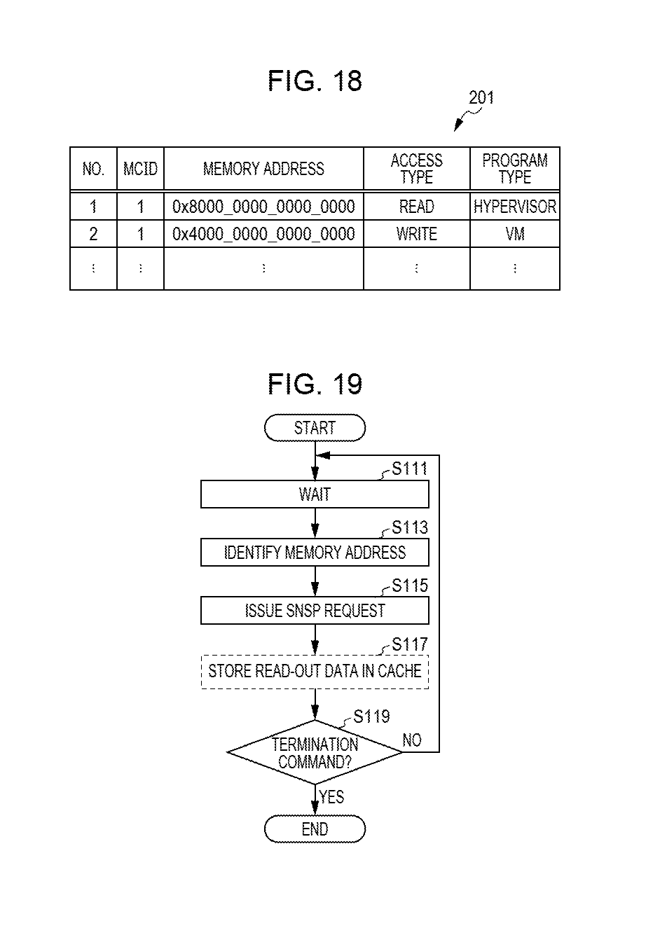

Next, processing performed by the memory access monitor unit (memory access monitor unit 2d) will be described with reference to FIGS. 17 and 18. First, the memory access monitor unit 2d waits for a command to start memory access monitoring (S91 in FIG. 17).

The memory access monitor unit 2d determines whether a command to start memory access monitoring has been received from the remote access management unit 104 (S93). If a command to start memory access monitoring has not been received from the remote access management unit 104 (No in S93), the processing returns to S91. If a command to start memory access monitoring has been received from the remote access management unit 104 (Yes in S93), the memory access monitor unit 2d determines whether each request to be processed by the memory controller 2b satisfies the conditions set in the filter table 202 (S95).

If there is no request that satisfies the conditions (No in S97), the processing returns to S95. If there is a request that satisfies the conditions (Yes in S97), the memory access monitor unit 2d writes information about the request that satisfies the conditions into the access history table 201 (S99). If the amount of information stored in the access history table 201 reaches an upper limit thereof, the oldest information is deleted to prevent an unlimited amount of information from being written to the access history table 201.

FIG. 18 illustrates an example of data stored in the access history table 201. In the example in FIG. 18, the access history table 201 stores therein, the number of each entry, a memory controller identifier (MCID), an address (an address from which the access started, for example) of an accessed memory, an access type (read, write, cache invalidation, or the like), and a type of the program that has generated the access.

The memory access monitor unit 2d determines whether a command to terminate monitoring has been received from the remote access management unit 104 (S101). If a command to terminate monitoring has not been received from the remote access management unit 104 (No in S101), the processing returns to S95. If a command to terminate monitoring has been received from the remote access management unit 104 (Yes in S101), the memory access monitor unit 2d clears the data stored in the access history table 201 (S103). Thereafter, the processing is terminated.

When the processing described above is performed, access history information may be acquired only for accesses to be monitored. Therefore, an amount of resources consumed in the memory controller may be suppressed.

Next, processing performed by the cache fill unit 105 will be described with reference to FIG. 19. First, the cache fill unit 105 waits for a time (100 milliseconds, for example) designated by the remote access management unit 104 (S111 in FIG. 19).

The cache fill unit 105 identifies, on the basis of the access history table 201, memory addresses from which data is to be read (S113). In S113, the memory addresses from which data is to be read are assumed to a page including the memory address indicated by the newest entry in the access history table 201 and the next page thereof. The size of these pages is the page size included in the execution command from the remote access management unit 104. In S113, pages are added and data is read out in accordance with newer entries in the access history table 201 starting from the newest entry until the size of read-out data becomes the size of the L3 cache.

For the memory addresses identified in S113, the cache fill unit 105 issues an SNSP request to the memory controller (memory controller 2b) for each cache line size (S115).

The SNSP request is issued when the cache fill unit 105 executes an SNSP command. In a CPU package that adopts a directory snoop method, the memory controller manages information that indicates a CPU package having a cache in which data at a memory address to be accessed is stored. However, the information is not correct at all times. For example, data thought to be stored in a cache may have been cleared by the CPU having the cache. In general, when a memory controller receives a read request, the memory controller issues a snoop command to the CPU package allocated with the memory in which data related to the request is stored. According to the second embodiment, when the memory controller receives an SNSP request, if the data is stored in a cache of another CPU package, the memory controller does not issue a snoop command and notifies a core, which has issued the SNSP request, that the data has already been stored in the cache of the other CPU package. Accordingly, if data to be read from a memory is already held in a cache of another CPU package, it is possible to suppress overhead, which would otherwise be involved when data is to be held by the snoop command in the CPU package in which the cache fill unit 105 is operating.

For example, if the size of the L3 cache is 40 megabytes, the page size is 4 kilobytes, and the cache line size is 64 bytes, then the number of pages is 10,240, so 655,360 SNSP requests are issued. If it is assumed that a time taken to access a local memory, which is not a remote memory, is 100 nanoseconds, when one core sequentially executes these commands, it takes about 66 milliseconds.

When the memory controller 2b reads out data in response to the SNSP request, the memory controller 2b stores the read-out data in the cache 2a (S117). Since this processing is not performed by the cache fill unit 105, S117 is indicated by dashed lines.

The cache fill unit 105 determines whether a processing termination command has been received from the remote access management unit 104 (S119). If a processing termination command has not been received (No in S119), the processing returns to S111. If a processing termination command has been received (Yes in S119), the processing is terminated.

When the processing described above is performed, the speed of accessing data stored in the remote memory may be increased and access prediction precision may be improved when compared with a case in which only software is used for implementation. Furthermore, no overhead of software occurs to acquire the history information about accesses.

### Third Embodiment

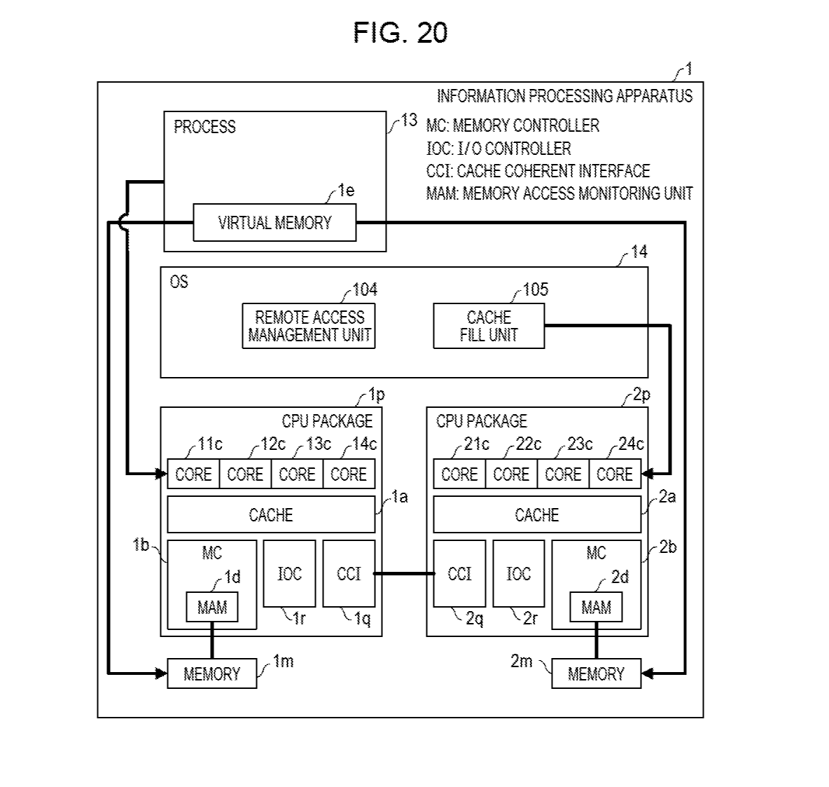

FIG. 20 illustrates a configuration of an information processing apparatus 1 according to a third embodiment. The information processing apparatus 1 includes a CPU package 1p, a memory 1m which is, for example, a DIMM, a CPU package 2p, and a memory 2m which is, for example, a DIMM. The memory 1m is allocated to the CPU package 1p, and the memory 2m is allocated to the CPU package 2p. The information processing apparatus 1 complies with the PCI Express standard.

The CPU package 1p includes cores 11c to 14c, a cache 1a, a memory controller 1b (abbreviated as MC in FIG. 20), an I/O controller 1r (abbreviated as IOC in FIG. 20), and a cache coherent interface 1q (abbreviated as CCI in FIG. 20). Similarly, the CPU package 2p includes cores 21c to 24c, a cache 2a, a memory controller 2b, an I/O controller 2r, and a cache coherent interface 2q.

The cores 11c to 14c and the cores 21c to 24c execute commands in programs. Each core according to the third embodiment has a cache snoop mechanism in a directory snoop method and adopts the MESIF protocol as the cache coherent protocol. Each core may execute an SNSP command used by a cache fill unit 105.

The caches 1a and 2a are each a storage area in which information (for example, addresses and data themselves) about memory accesses performed by cores is stored. According to the third embodiment, each CPU package includes an L1 cache, an L2 cache, and an L3 cache. The L3 cache is shared among the cores.

The memory controllers 1b and 2b each control accesses to the relevant memory. The memory controller 1b includes a memory access monitor unit 1d (abbreviated as MAM in FIG. 20) and is coupled with the memory 1m. The memory controller 2b includes a memory access monitor unit 2d and is coupled with the memory 2m.

The I/O controllers 1r and 2r, each of which is a controller used for a connection to an I/O interface such as the PCI Express, perform processing to convert a protocol used in the relevant CPU package into an I/O interface protocol and perform other processing.

The cache coherent interfaces 1q and 2q are each, for example, the Intel QPI or the Hyper Transport. The cache coherent interfaces 1q and 2q perform communications with another CPU package such as, for example, communications to maintain cache coherency.

Programs for an OS 14 are stored in at least either one of the memories 1m and 2m, and are executed by at least either one of a core in the CPU package 1p and a core in the CPU package 2p. The OS 14 manages assignment of hardware to a process 13. The OS 14 includes a remote access management unit 104 and a cache fill unit 105.

The process 13 is implemented when a program corresponding thereto is executed by at least either one of a core in the CPU package 1p and a core in the CPU package 2p. When the process 13 performs processing, a virtual memory 1e is used. The virtual memory 1e is implemented by the memories 1m and 2m. That is, from the viewpoint of the process 13, the memory 2m is a remote memory. The cache fill unit 105 is implemented when a program corresponding thereto is executed by the core 24c. The program for the cache fill unit 105 may be executed by a plurality of cores. The program for the remote access management unit 104 may be executed by any core.

In the third embodiment, if the OS 14 performs similar processing to the processing performed by the hypervisor 10 in the second embodiment, the process 13 performs similar processing to the processing performed by the VM 12 in the second embodiment, and the virtual memory 1e is used in similar way to that for the guest physical memory 1g, a similar effect as in the second embodiment may be obtained. That is, the speed of accessing the memory 2m by the process 13 may be increased.

So far, embodiments of the present disclosure have been described. However, the present disclosure is not limited to these embodiments. For example, there is a case in which the functional configuration of the information processing apparatus 1 described above may differ from the configuration of actual program modules.

The configuration of each table described above is only an example. The configurations described above may not be followed. The sequences of the processing flows may be changed as long as the processing result remains the same. A plurality of processing may be concurrently performed.

The embodiments of the present disclosure described above will be summarized below.

An information processing apparatus as a first aspect of the embodiments includes a first processor, a memory coupled with the first processor, and a second processor that implements a virtual machine that accesses the memory. The first processor reads out data from an area of the memory that the virtual machine accesses, and performs processing to store the read-out data in a cache of the first processor.

Then, it suffices for the virtual machine to access data stored in the cache of the first processor, so the speed of accessing data stored in a memory (remote memory), which is coupled with a CPU that is not assigned to the virtual machine, by the virtual machine may be increased. This may be implemented without changing hardware.

The first processor or second processor may acquire information about accesses that the virtual machine has made to the memory. The first processor may identify, based on the acquired information about accesses, the area of the memory, which is to be accessed by the virtual machine and may read out the data from the identified area of the memory. This may raise a cache hit ratio and enables the speed of accessing data stored in the remote memory to be increased.

The first processor or second processor may acquire information about the number of cache misses made by the second processor. The first processor may determine a method of reading out data, based on the acquired information about the number of cache misses and may read out the data from the identified area of the memory by the determined method. This enables data to be read out in a method that reduces a cache miss ratio.

The first processor may include a memory controller that may acquire history information about accesses that the virtual machine has made to the memory. The first processor may identify, based on the history information acquired by the memory controller, a memory address to be accessed by the virtual machine. The first processor may read out the data from an area including the identified memory address. This may raise a cache hit ratio and enables the speed of accessing data stored in the remote memory to be increased. Furthermore, no overhead of software occurs to acquire the history information about accesses.

The memory controller may manage conditions under which accesses made by the virtual machine are extracted from accesses to the memory, and may acquire history information about accesses that satisfy the conditions. This may narrow down accesses about which history information is acquired, so much more history information about target accesses may be saved.

The information about accesses may include information that indicates a ratio of types of accesses to an individual area and information about the number of accesses to the individual area.

The history information about accesses may include information that indicates the type of an access to an individual memory address and information about a program that has caused the access to the individual memory address.

A method for caching as a second aspect of the embodiments includes processing in which an access is made to a memory coupled with a first processor and data is read out from an area of the memory, which is accessed by a virtual machine implemented by a second processor. The method also includes processing in which the read-out data is stored in a cache of the first processor.

A program that causes the first processor to perform the processing in the method described above may be created. The created program is stored, for example, on a computer-readable recording medium (storage unit); examples of the computer-readable recording medium include a flexible disk, a compact disk-read-only memory (CD-ROM), a magneto-optic disk, a semiconductor memory, and a hard disk. Intermediate processing results are temporarily stored in a storage unit such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory;
a second processor configured to
implement a virtual machine that accesses the memory; and
a first processor coupled with the memory and the first processor configured to
read out first data from a first area of the memory, the first area being to be accessed by the virtual machine, and
store the first data in a cache of the first processor.

2. The information processing apparatus according to claim 1, wherein
the first processor or the second processor is configured to
acquire first information about accesses that the virtual machine has made to the memory, and
the first processor is configured to
identify the first area on basis of the first information.

3. The information processing apparatus according to claim 2, wherein
the first processor or the second processor is configured to
acquire second information about a number of cache misses made by the second processor, and
the first processor is configured to
determine, on basis of the second information, a first method of reading out data, and
read out the first data from the first area by the first method.

4. The information processing apparatus according to claim 1, wherein
the first processor is configured to
acquire first history information about accesses made by the virtual machine to the memory,
identify a first memory address on basis of the first history information, the first memory address being to be accessed by the virtual machine, and
read out the first data from an area including the first memory address.

5. The information processing apparatus according to claim 4, wherein
the first processor is configured to
manage conditions under which accesses made by the virtual machine are extracted from accesses to the memory, and
acquire, as the first history information, history information about accesses that satisfy the conditions.

6. The information processing apparatus according to claim 2, wherein
the first information includes information that indicates a ratio of types of accesses to an individual area and information about a number of accesses to the individual area.

7. The information processing apparatus according to claim 4, wherein
the first history information includes information that indicates a type of an access to an individual memory address and information about a program that has caused the access to the individual memory address.

8. A method for caching, the method comprising:
reading out, by a first processor, first data from a first area of a memory coupled with the first processor, the first area being to be accessed by a virtual machine implemented by a second processor different from the first processor; and
storing the first data in a cache of the first processor.

9. A non-transitory computer-readable recording medium having stored therein a program that causes a first processor to execute a process, the process comprising:
reading out first data from a first area of a memory coupled with the first processor, the first area being to be accessed by a virtual machine implemented by a second processor different from the first processor; and
storing the first data in a cache of the first processor.
